(19) United States
(12) Patent Application Publication
(10) Pub. No.: US 2017/0174425 A1
(43) Pub. Date: Jun. 22, 2017

(54) FOLDAWAY BRACKET FLEXIBLE LIQUID STORAGE TANK

(71) Applicant: Beijing Sihai Futong Energy Technology Co.,Ltd., Beijing (CN)

(72) Inventor: Yunzheng Huang, Beijing (CN)

(21) Appl. No.: 14/796,811

(22) Filed: Jul. 10, 2015

(51) Int. Cl. B65D 90/20; B65D 88/16

(52) U.S. Cl. CPC B65D 90/205; B65D 88/16; F16K 1/22

(57) ABSTRACT

The present invention relates to a foldaway bracket flexible liquid storage tank, comprising a bracket, a flexible storage tank disposed in the middle of the bracket, wherein the bracket further comprising a pedestal, wherein the pedestal further comprising a upper substrate and a lower substrate, wherein a plurality of water pipes are disposed between the upper substrate and the lower substrate, wherein the said water pipes are connected with catch basin; and wherein butterfly valves are disposed in the inlet end and outlet end of the water pipes, wherein a foldaway apparatus is disposed on the said upper substrate.

### TECHNICAL FIELD

The present invention relates to a foldaway bracket flexible liquid storage tank.

### BACKGROUND

In petroleum technology field, flexible liquid storage tank is widely used to transport and storage liquid object. With the progress of science and technology, there are many kinds of flexible liquid storage tank that include lateral foldaway flexible liquid storage tank. The conventional lateral foldaway hydraulic bracket flexible liquid storage tank is widely used to storage and transport of fracturing fluid in the major oil fields and natural gas fields. The flexible liquid storage tank saves cost and storage space in long distance transportation especially. However, the conventional structure of the existing flexible liquid storage tank is fixed, therefore difficult to operate, load and unload. The disadvantage of the existing flexible liquid storage tank are as follows: waste of time and effort, the cost of transport and labor are higher, and difficult to be transported. In recent years, cost-saving flexible liquid storage tank has emerged, that attains the foldaway effect through fork sliding structure and foldaway connecting rod. However, the flexible liquid storage tank of this kind of structure can only be fitted to the height of horizontal flexible liquid storage tank rather than that of vertical flexible liquid storage tank. Furthermore, only by means of external force, can the foldaway flexible water storage tank bracket be expanded. For example, the upper frame of the bracket flexible liquid storage tank is lifted by crane or forklift in order to expand the bracket.

Therefore, a flexible liquid storage tank capable of resolving the above problems is needed.

### SUMMARY OF THE INVENTION

The present invention is directed to a foldaway bracket flexible liquid storage tank, which can comprise a bracket and a flexible storage tank disposed in the middle of the bracket, the bracket can comprise a pedestal, the pedestal can comprise an upper substrate and a lower substrate, wherein a plurality of waterpipes are disposed between the upper substrate and the lower substrate, the waterpipes are connected with catch basin and wherein butterfly valves are disposed in the inlet end and outlet end of the waterpipes, wherein a foldaway apparatus is coupled with the upper substrate and disposed on it.

Preferably, the said foldaway apparatus can comprise a plurality of pillars, cross spacer to be mounted on the upper end of the pillar, wherein the cap steel plate corresponds with the pedestal to be disposed on the upper end of the cross spacer, the upper middle part of the said upper substrate is flexibly connected with a plurality of foldaway upright posts by the first connection, wherein the angle of the foldaway upright post is 90°.

In another embodiment, the said foldaway apparatus can comprise a support base to be disposed symmetrically on pedestal, wherein the upper end of the support base connects with the suited foldaway rod. Wherein a lifting device is disposed on the foldaway rod. The lifting device can comprise euphroe, rope and fixed pulley. The euphroe is disposed on the said foldaway rod, and the fixed pulley is mounted on the upper end of the said foldaway rod. Support bar is disposed on the upper edge of the said flexible liquid storage tank. The one end of the rope is fixed on the euphroe, the other end of the rope which bypass the fixed pulley connects with the said support bar. Rod aperture is equipped with the bottom of the foldaway rod. Base aperture which suited with rod aperture is equipped on the support base. Magnet is disposed on the foldaway and euphroe.

In another embodiment, the said foldaway apparatus can comprise a plurality of first support rod and second support rod to be disposed symmetrically between the upper substrate and the lower substrate. The upper and lower end of the first support rod is hinged in the upper substrate and the lower substrate. The first support rod and the second support end are comprised by two little support rod hinged with each other. The foldaway upright post comprises the first foldaway post and the second foldaway post. The first foldaway post and the second foldaway post connect flexibly with each other by the second connection. The two sides of the upper of the upper substrate connect with a plurality of upright post by the third connection, the upright post connects with the said cross spacer. The upper of the second support rod is fixed on the upper substrate by pin. The lower of the second support rod is welded on the lower substrate. The third support rod which is welded on the lower substrate is to be disposed between the second support rod. The vertical height of the third support rod is greater than that of hinged part of the second support.

It is to be understood that both the foregoing general description and the following detailed description are exemplary only and are not necessarily restrictive of the disclosure as claimed. The accompanying drawings, which are incorporated in and constitute a part of the specification, illustrate an embodiment of the disclosure and together with the general description, serve to explain the principle of the disclosure.

### BRIEF DESCRIPTION OF THE DRAWINGS

The numerous advantages of the present invention may be better understood by those skilled in the art by reference to the accompanying figures in which:

FIG. 1 is the first structure schematic drawing of a foldaway bracket flexible liquid storage tank according to the first embodiment of the present invention; and

FIG. 2 is the second structure schematic drawing of a foldaway bracket flexible liquid storage tank according to the first embodiment of the present invention; and

FIG. 3 is the first structure schematic drawing of a foldaway bracket flexible liquid storage tank according to the second embodiment of the present invention; and;

FIG. 4 is the second structure schematic drawing of a foldaway bracket flexible liquid storage tank according to the second embodiment of the present invention; and;

FIG. 5 is the third structure schematic drawing of a foldaway bracket flexible liquid storage tank according to the second embodiment of the present invention; and;

FIG. 6 is the first structure schematic drawing of a foldaway bracket flexible liquid storage tank according to the third embodiment of the present invention; and;

FIG. 7 is the second structure schematic drawing of a foldaway bracket flexible liquid storage tank according to the third embodiment of the present invention.

### DETAILED DESCRIPTION

Reference will now be made in detail to the subject matter disclosed, which is illustrated in the accompanying drawings.

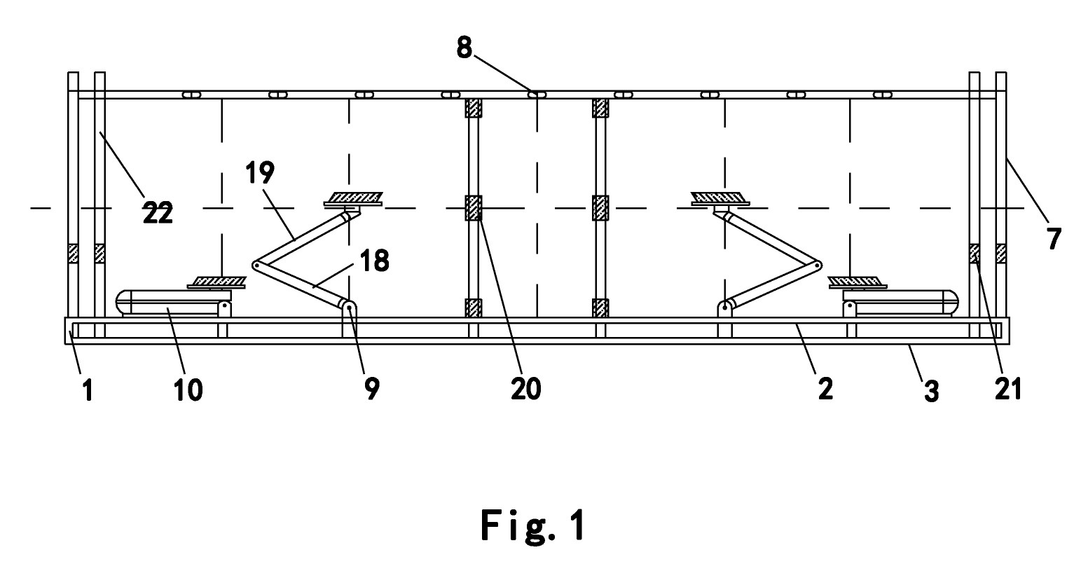

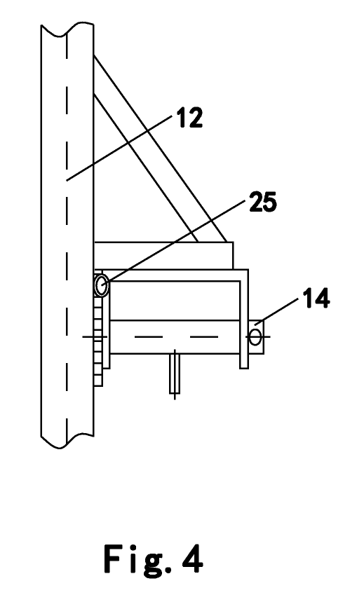

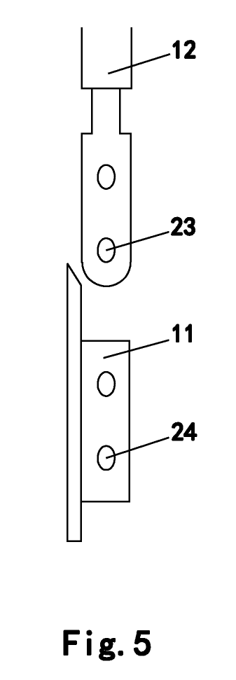

Referring to FIGS. 1-7, the present invention relates to a foldaway bracket flexible liquid storage tank, that can comprise a bracket and a flexible storage tank disposed in the middle of the bracket, wherein the bracket can comprise a pedestal 1, wherein the said pedestal 1 can comprise an upper substrate 2 and a lower substrate 3, wherein a plurality of water pipes 4 are disposed between the upper substrate 2 and the lower substrate 3, wherein the water pipes 4 are connected with a catch basin 5 and wherein butterfly valves 6 are disposed in the inlet end and outlet end of the waterpipes 4, wherein a foldaway apparatus is disposed on the upper substrate 2.

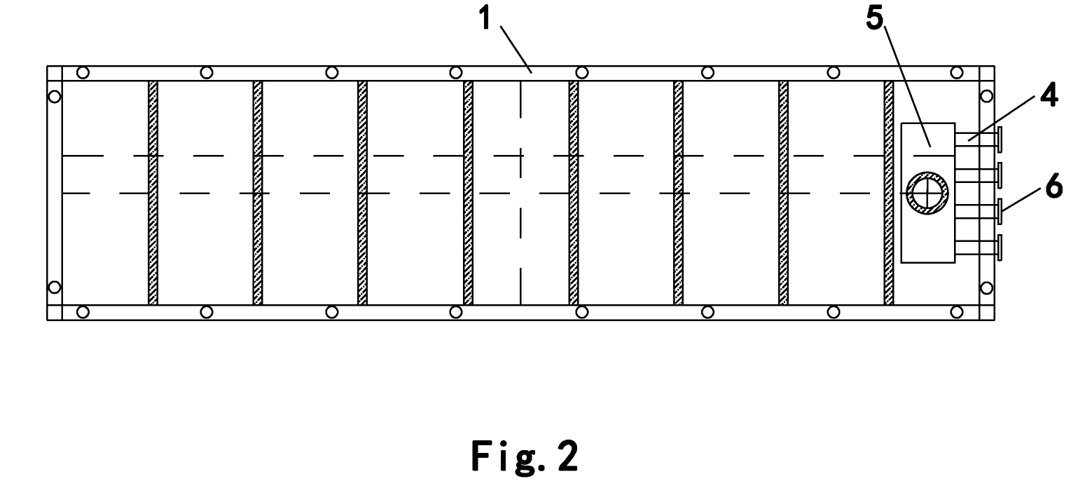

Referring to FIGS. 1-2, in one embodiment, the said foldaway apparatus can comprise a plurality of pillars 7, a cross spacer 8 disposed on the upper end of the pillar 7, a cap steel plate which is matched with pedestal 1 disposed on the upper end of the cross spacer 8, wherein the upper middle part of the said upper substrate 2 is flexibly connected with a plurality of foldaway upright posts 10 by the first connection 9, the angle of the foldaway upright post 10 is 90°.

The foldaway upright post 10 can comprise a first foldaway post 18 and a second foldaway post 19. The first foldaway post 18 and the second foldaway post 19 are flexibly connected with each other by a second connection 20. The two sides the upper substrate 2 connect with a plurality of upright post 22 by a third connection 21, wherein the upright post 22 connects with the said cross spacer 8.

The foldaway bracket flexible liquid storage tank in one embodiment of present invention can comprise polyurethane coated fabric material which insulate effectively liquid in the tank and the bracket. Furthermore, the upright post can finalize the design and assistant support the reference devices. The upright post which connected with each other by pin can fold and fix. The top of pillars connects with each other by cross spacer. And then the cross spacer supports the bracket and fixes the position by pin, which can be used to load. The cap steel plate is disposed on the upper end of the cross spacer, and there can be two apertures disposed on the cap steel plate in order to watch the state of liquid in flexible liquid storage tank. The catch basin is disposed in the pedestal. There can be apertures disposed on the catch basin, which connects with the flexible liquid storage tank consisted of polyurethane coated fabric material. The catch basin connects with external space by water pipes, which can import and export liquid. Hoisting hook is disposed on the upper and lower sides of bracket in order to convenient lifting.

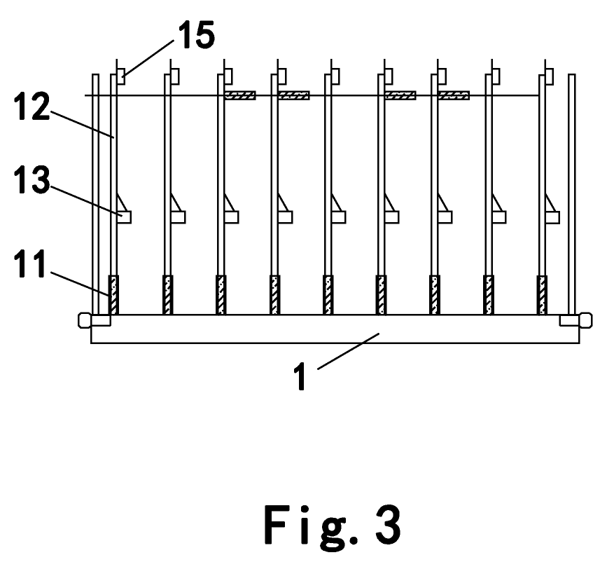

Referring to FIGS. 3-5, in the second embodiment, the said foldaway apparatus include support base 11 to be disposed symmetrically on pedestal 1, the upper end of the support base 11 connects with the suited foldaway rod 12. On the foldaway rod 12, lifting device 13 is to be disposed. The lifting device 13 includes euphroe 14, rope and fixed pulley 15. The euphroe 14 is disposed on the said foldaway rod 12, and the fixed pulley 15 is mounted on the upper end of the said foldaway rod 12. Support bar is disposed on the upper edge of the said flexible liquid storage tank. The one end of the rope is fixed on the euphroe 14, the other end of the rope which bypass the fixed pulley 15 connects with the said support bar. Rod aperture 23 is equipped with the bottom of the foldaway rod 12. Base aperture 24 which suited with rod aperture 23 is equipped on the support base 11. Magnet 25 is disposed on the foldaway rod 12 and euphroe 14.

When using, the foldaway is fixed on the support base. Rotating the euphroe to twine rope, the flat flexible liquid storage tank is hiked and then it forms the supported flexible liquid storage tank. When transport and located the apparatus without liquid, oppositely rotating the euphroe to loosen rope and then the flexible liquid storage tank drops down. Reclining the foldaway rod, the volume of the apparatus turn smaller, which is convenient to transport and store. Owing to the height of equal height of beam and stinger is lesser than that of square frame, the upper of sealed outlet box disposed on square frame is lesser than that of the lower of beam and stringer which is convenient to output liquid when liquid in the flexible liquid storage tank is transported outward. For the reason of gravity, the liquid in the flexible liquid storage tank flow towards low-lying area. Open the butterfly valves disposed on the end of the inlet and outlet water pipes, liquid in the flexible liquid storage tank is transported completely. The transportation speed and transportation efficiency of liquid improve effectively. The height of pedestal is reduced in a certain extent in order to save materials.

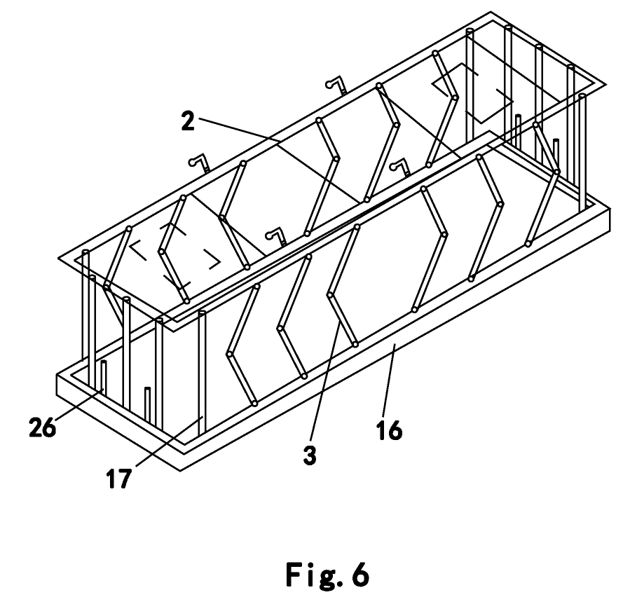

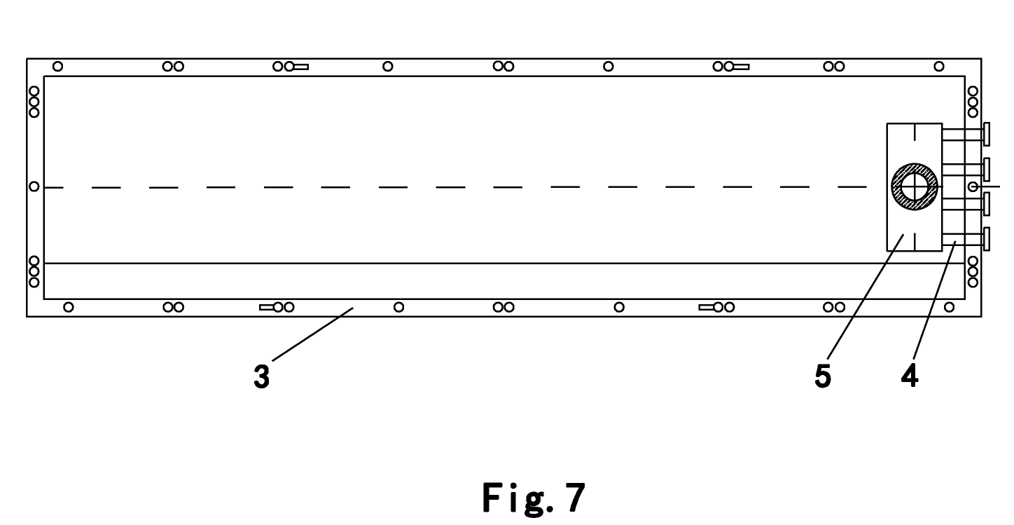

Referring to FIGS. 6-7, in another embodiment, the said foldaway apparatus include a plurality of first support rod 16 and second support rod 17 to be disposed symmetrically between the upper substrate 2 and the lower substrate 3. The upper and lower end of the first support rod 16 is hinged in the upper substrate 2 and the lower substrate 3. The first support rod 16 and the second support rod 17 are comprised by two little support rod hinged with each other. The upper of the second support rod 17 is fixed on the upper substrate 2 by pin. The lower of the second support rod 17 is welded on the lower substrate 3. The third support rod 26 which is welded on the lower substrate 3 is to be disposed between the second support rod 17. The vertical height of the third support rod 26 is greater than that of hinged part of the second support 17.

When using, the bracket can fold and narrow floor space in order to transport conveniently. The cap steel plate is disposed on the upper frame and the lower frame. There are two apertures disposed on the cap steel plate in order to watch the state of liquid in flexible liquid storage tank. The flexible liquid storage tank consists of polyurethane coated fabric material. The weight of the polyurethane coated fabric material is light and the material quality is environmental adaptability. It can fold easily. A plurality of hooks are disposed on the two sides transfers frame of the upper frame and the hook is contribute to lift easily.

What is claimed is:

1. A foldaway bracket flexible liquid storage tank, comprising:
a bracket;
a flexible storage tank disposed in the middle of the bracket,
wherein the bracket further comprising a pedestal, wherein the pedestal further comprising a upper substrate and a lower substrate, wherein a plurality of water pipes are disposed between the upper substrate and the lower substrate, wherein the said water pipes are connected with catch basin; and wherein butterfly valves are disposed in the inlet end and outlet end of the water pipes, wherein a foldaway apparatus is disposed on the said upper substrate.

2. The foldaway bracket flexible liquid storage tank as set forth in claim 1, wherein the said foldaway apparatus comprising a plurality of pillar, a cross spacer to be mounted on the upper end of the pillar, a cap steel plate disposed on the upper end of the cross spacer, wherein the upper middle part of the said upper substrate is flexibly connected with a plurality of foldaway upright posts by the first connection, and wherein the angle of the foldaway upright post is 90°.

3. The foldaway bracket flexible liquid storage tank as set forth in claim 2, wherein the foldaway upright post comprising a first foldaway post and a second foldaway post; wherein the first foldaway post and the second foldaway post are connected flexibly with each other by a second connection; wherein the two sides of the upper of the upper substrate are connected with a plurality of upright post by a third connection, wherein the a plurality of upright post is connected with the said cross spacer.

4. The foldaway bracket flexible liquid storage tank as set forth in claim 1, wherein the said foldaway apparatus comprising a support base disposed symmetrically on pedestal, wherein the upper end of the support base is connected with the suited foldaway rod; wherein a lifting device is disposed on the foldaway rod; wherein the lifting device further comprise an euphroe, a rope and a fixed pulley; wherein the euphroe is disposed on the said foldaway rod, and wherein the fixed pulley is mounted on the upper end of the said foldaway rod; wherein a support bar is disposed on the upper edge of the said flexible liquid storage tank; wherein one end of the rope is fixed on the euphroe, and wherein the other end of the rope bypasses the fixed pulley and is connected with the said support bar.

5. The foldaway bracket flexible liquid storage tank as set forth in claim 4, wherein bottom of the foldaway rod comprising a rod aperture; wherein the said support base comprising a base aperture corresponding to the base aperture; wherein a plurality of magnet is disposed on the foldaway and euphroe.

6. The foldaway bracket flexible liquid storage tank as set forth in claim 1, wherein the said foldaway apparatus comprising a plurality of first support rod and a plurality of second support rod disposed symmetrically between the upper substrate and the lower substrate; wherein the upper and lower end of the first support rod are connected to the upper substrate and the lower substrate; wherein the first support rod and the second support rod each comprising two little support rod hinged with each other.

7. The foldaway bracket flexible liquid storage tank as set forth in claim 6, wherein the upper end of the second support rod is fixed on the upper substrate by a pin; and wherein the lower of the second support rod is welded on the lower substrate.

8. The foldaway bracket flexible liquid storage tank as set forth in claim 7, wherein a third support rod is welded on the lower substrate and disposed between the second support rods; the vertical height of the third support rod is greater than that of hinged part of the second support.
